(19) United States
(12) Patent Application Publication
(10) Pub. No.: US 2002/0131770 A1
(43) Pub. Date: Sep. 19, 2002

(54) Color modeling of a photographic image

(76) Inventors: Roland Meier, Aarau (CH); Peter Zolliker, Dielsdorf (CH)

Correspondence Address: PENNIE AND EDMONDS, 1155 AVENUE OF THE AMERICAS, NEW YORK, NY, 100362711

(21) Appl. No.: 10/053,629

(22) Filed: Jan. 22, 2002

(30) Foreign Application Priority Data
Jan. 19, 2001 (DE) 01 101 128.5

(51) Int. Cl. H04N 5/225; G02B 13/16; H04N 5/76

(52) U.S. Cl. 386/117; 348/335

(57) ABSTRACT

A model is disclosed for a system of an image reproducing device and a medium, which produces an image by way of light modulators. A relationship between image control data and light modulation values is described by the model. A relationship is generated between the light modulation values and the modulation color values by a modeled light incidence onto the light modulators.

### FIELD OF THE INVENTION

The present invention relates to processes for the reproduction for color photographs. More particularly, the invention relates to a process for the modeling of photographic images when produced by light modulators in response to image control data for the control of image reproduction devices therewith. The invention relates especially to the field of photography, processing of photographic data and photolabs.

### BACKGROUND ART

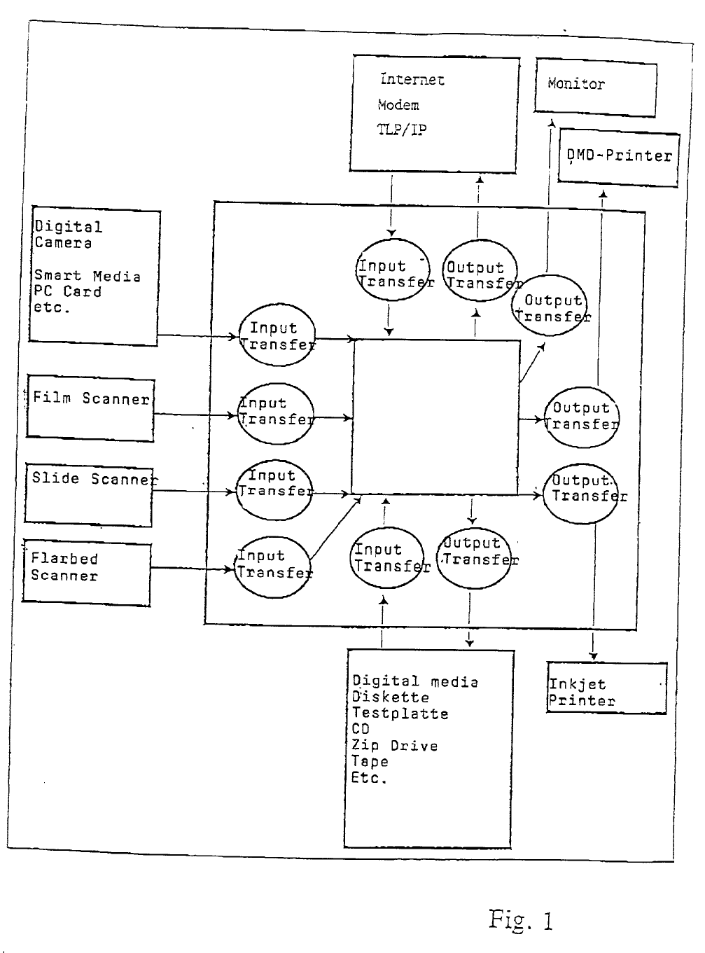

Photolabs of today, especially so called digital minilabs, which represent a compact realization of a photolab on a small floor surface (typically less than a few square meters or one square meter) are multifunctional. They receive data through different input channels and distribute output data to one output device or several output devices. An example for the networked data stream and information stream of a minilab is shown in FIG. 1. Several of the input/output devices can only handle input information or input data (for example, a scanner for films or negative films) or only handle output data or information (for example a printer). Other devices support the data flow in both directions and serve both as input as well as output devices (for example the reading of or writing to a CD or a data transfer through a network or the internet).

Each input device and output device handles the image information present in the images in the manner which is specific for the device. This results in problems upon conversion of the color information during exchange of image data between the devices. It is known for the solution of such problems to use a so called ICC (International Color Consortium) standard which serves as a platform for the conversion of the color data. It is thereby the goal to convert the device specific color data into a device unspecific color space from which one can then again transform into device specific color spaces. This is correspondingly described, for example, in the article “Color Management: Current Practice And The Adoption Of A New Standard” by Michael Has and Todt Newman, which is described under the internet address http://www.color.org/wpaper1.html. For the production of so-called ICC profiles, which allow a transformation of a device specific color space into the device unspecific color space, the respective device is considered as a black box and a profile is produced by way of a multitude of color patters which are produced or processed by the device. The generation of the ICC profiles is thereby very involved.

Each change in the system which describes the black box requires the generation of a new profile. A change in the system is, for example, a change of the maximum density of the paper due to a change of the paper development.

The inventors of the present invention have discovered that a color space platform for the conversion of data between the different input and output devices would be advantageous also in the field of photolabs, especially minilabs as well as large scale labs. However, the application of the ICC principle was found to be too costly to achieve good results during the color image production. Especially, a multitude of measurements is required for the generation of a profile of the necessary precision.

### SUMMARY OF THE INVENTION

It is an object of the invention to process image data for the color image generation in such a way that the conversion between a given system platform colorspace and a device specific color space can be simplified.

In accordance with the invention, a color space, especially for a lab or minilab, is provided which serves as platform for color space transformations and therefore as either a starting point or an endpoint of a color space transformation. In order to reduce the measurement effort during the generation of a profile for the transformation from one color space to another, the image reproduction system which implicates or causes the color space transformation is, contrary to the prior art, not treated as a black box, but modeled. Thereby, upon a change in the system, for example, only one parameter (or only a few parameters) of the model need be adapted.

Accordingly, the invention provides a process for the modeling of photographic images reproduced with light modulators. Light modulators are, for example, pigments or interference filters, wherein the light transparency through the interference filters is controllable, for example, with liquid crystals. Light modulators modulate or change the intensity and spectrum of the incident light. Light modulators reflect, absorb and/or transmit the incident light, wherein the incident light is reflected wavelength dependent, absorbed and/or transmitted. Absorption, reflection and transmission properties are generally wavelength dependent.

The present invention especially provides a process for the modeling of how an image appears to an observer or to a measuring device with several defined color channels, whereby the image is produced by an image reproduction system, which produces the image by way of light modulators and which is controlled by suitable image control data. The image control data can thereby directly control the light modulators (for example the elements of an LCD display) or indirectly affect the generation of light modulators (for example the generation of pigments by control of an illumination unit with the image control data, wherein the illumination unit exposes photographic paper). The invention also provides a process inverse thereto for the calculation for a given image of how an image reproduction system is to be controlled in order to produce the image.

The process of the present invention is preferably intended for use in image reproduction systems, which consist of image reproduction devices and a medium, whereby the image reproduction device especially produces the light modulators in the medium or applies them thereto. The medium can thereby be reflective and/or transparent, so that the image can be observed in reflection or transmission.

The invention further provides an image reproduction system in which the light modulators are not produced but right from the beginning have their light modulation properties and are arranged for the image reproduction, as is the case, for example, with a field of interference filters coupled with light intensity modulators (for example liquid crystals or LCD display).

The present invention provides a process for the color modeling of a photographic image reproduced on a medium (for example, photographic paper or regular paper printed with color) by way of pigments and more preferably to the use of the model in a (first) process for determining the color data of the photographic image on the basis of given image control data, which describe the color values of the light reflected, transmitted and/or absorbed by the image, and in a (second) process for determining the image control data associated with given color data of an image. The image control data serve the control of an image reproduction device which produces an image on a photographic image medium by way of pigments. The color data preferably describe the colors of the image as perceived by a (standard) human, whereby the image, for example, is observed in reflection or transmission. By way of the color data, spectra are represented by discreet values. Commonly, three values are used corresponding to the human eye. The color values are preferably obtained from the spectra by folding with functions which represent, for example, the sensitivity curves of the human eye. However, they can also be obtained by folding with other functions such as, for example, with the production of ANSI-A-cover data. The functions used thereby are more narrow band than the sensitivity curves of the human eye and correspond especially to the sensitivity curves of a color densitometer. Both processes are based on the common color model for the photographic image and respectively represent the execution of the other process in opposite direction.

The invention further provides a program for carrying out the process in accordance with the invention, a storage medium with the program, as well as a printing device or printer, operating according to the process in accordance with the invention, as well as a photolab, especially a minilab or a large scale lab and apparatus for large scale labs, which use the process in accordance with the invention.

An image reproduction device which is a component of the image reproduction system is, for example, a device which in or on a medium produces pigments in order to make an image apparent to an observer by light reflection on the medium. Such systems made of image reproduction device, medium and pigments, are in the following also referred to as pigment systems and represent one example of an image reproduction system. The pigment systems are thereby especially printing devices or printer which, for example, deposit pigments onto a medium (for example color toner in electrophotographic printers, for example laser printers, or colored ink in inkjet printers), or devices which produce pigments in the medium, such as thermocolor printers, or by illumination of light sensitive media (for example photographic paper), for example by way of lasers, cathode rays, light guides or DMD's (digital mirror devices). The media (photographic image media) can be, for example, paper, foils or other multilayered materials.

According to the invention, a model is provided which allows on the one hand the modeling of how an image would appear after reproduction with a pigment system for given image control data which are to control the image reproduction. On the other hand, the model allows the calculation of the image control data required for the control of the image reproduction to achieve a given image.

Examples of light modulators were already given, such as pigments and interference filters. In the following, exemplary reference is made to pigments instead of light modulators. The light modulation data describe the light modulation by the light modulators. The light modulation data preferably have a direct or functional relationship to the characteristic (modeled) physical properties of the image reproduction system which describe the light modulation. Especially, a light modulation value is a measure for how strongly a certain light modulator contributes to the overall light modulation. A light modulation value describes especially the strength of the pigment production in the photographic paper or the concentration of the pigment produced. The light modulation value can also take into consideration the reflection values of the medium in or on which the pigment is found.

In accordance with the invention, the light modulation values are calculated based on a model which models the answer of an image reproduction system to image control data, which system therefore is in the following referred to as “image reproduction system model”. It is an advantage of the invention that it is considered how an image reproduction system generates the light modulation data in response to image control data. Therefore, the corresponding production properties of the image reproduction system are preferably also considered for the modeling.

The light modulation values are especially values which are directly connected with control data such as, for example, pigment control data which control and determine the modulation strength of the light modulator. The modulation properties of the light modulators (for example pigments) can be spectrally measured and play a roll especially in the determination of the modulation color values (of the modeled image) from the light modulation values (for example, pigment concentration). The light modulation values describe especially the intensity dependent or weighting dependent answer of the image reproduction system to the input image control data. The light modulation values have the property that for suitable transformed light modulation properties (for example spectral behavior of the pigments) the following conditions are especially fulfilled:

Preferably only one clearly determined transformed light modulation property which is independent of the other light modulation values exist for each modulator with associated, given light modulation value. Furthermore, a clear rule exists on how new transformed light modulation properties can be generated which correspond to a combination of light modulation values from given light modulation values of different light modulators and the associated, transformed light modulation properties. The resulting light modulation property can be determined by reverse transformation of the transformed light modulation property. Especially, the above described transformation of the light modulation properties must be reversible within the field of application.

Especially, the rule on how for a set of given light modulation values the associated transformed light modulation property is determined can consist of a linear combination by which the transformed light modulation properties of the individual light modulators are weighted with the associated light modulation values. Refinements of the model can break through both the linearity as well as the independence in the transformed space, in that, for example, (small) corrections are introduced depending on all or several light modulation values.

When the input image control data are exactly reproduced, for example, by a certain type of light modulator or by its spectral properties, the light modulation values can be brought into proportional relationship with the color intensity described by the image control data.

Before the invention is further described in the following, the terms used herein are again discussed. Light modulators are physical devices such as, for example, LCD displays or liquid crystals or physical materials such as, for example, pigments, which modulate light with respect to its intensity and/or with respect to its spectrum. “Light modulation values” are for example pigment concentrations. More generally, they represent weighting factors in a suitably transformed space. In that space, the individual light modulators (for example pigments) can be treated especially as mutually decoupled quantities. New spectra can thereby be generated by a clear rule. Light modulation values are mathematical values or data which flow into the model calculation. The term “modulation strength” or the corresponding term “modulation intensity” describes the physical phenomenon underlying the light modulation value, namely the strength with which the light is modulated and therefore changed. The change of the light is apparent especially in the way of a changed intensity and a changed spectrum. The term “control values” defines the control data input into an image reproduction system, whereby the image reproduction is carried out on the basis of these control data. The control data are therefore herein also referred to as “image control values” or “image control data”. In the case of the production of the image with pigments, they are also referred to as “pigment control values”. An example for “control values” are the RGB values, which are input into a printer. The herein referred to “color values” are especially a finite set of scalar quantities (typically 3, less than 10), which are created by folding the reflection spectrum with sensitivity curves. Examples are CIE-Lab, status ANSI-A densities and so on. The “light modulation properties” describe, for example, the spectral behavior of a pigment at a certain pigment concentration or depending on the pigment concentration.

Preferably, the system in accordance with the invention therefore operates in two steps, whereby in a step 1 it is determined how the image reproduction system responds to incoming image control data in order to thereby describe the modulation strength. The examples herefor are the amount of ink of an ink of a specific type, which is ejected in response to the image data, or the thickness of the color layer initiated by light in a photographic paper by given image control data.

While in a step 1, the relationship between the light modulation values which describe the modulation strength and the input image data is described on the basis of the specific properties (production properties) of the image reproduction system, the relationship between the light modulation values and the modulation color values (of the modeled image) is produced in a step 2. In this step 2, the spectral modulation properties of the light modulator types given for the image reproduction system are then used. The spectral modulation properties are preferably described as spectra (and not by colors) i.e., for example, wavelength or frequency dependent or correspondingly by a multitude of supporting points (preferably more than 10).

In connection with the modulation strengths described by the light modulation values with the spectral modulation properties described by the light modulation properties, the modulation color values can then be determined. The modulation color values describe, for example, the color values which an observer perceives upon observation of the modeled image on the basis of the light modulation properties of the light modulators at a given model illumination. Alternatively, they can also be, for example, the values measured by a color densitometer.

The light modulation values and the modulation strengths described thereby relate preferably to specific image regions, for example, image cells, pixels or image points. The image regions can thereby also include several image points formed by light modulators, which are influenced with respect to their light modulation properties especially also by a medium which, for example, forms a background.

In other words, a range of light modulation values results for each type of light modulator by which, for example, the modulation strength can be described. The image reproduction system model then sets in step 1 the position of the light modulation value within this range. This range is especially one dimensional, as is given with modulation strengths and it particularly does not relate to any spectral dependencies. An over expression caused by the image reproduction system can be described as correction. This over expression relates to the production of light modulators of another type by the image reproduction system, although the image control data are given only for the production of a specific type of light modulator. For example, upon illumination of a photographic paper with light of a specific color, not only the pigment complementary to the color can be excited, but also further pigments. The present invention therefore exploits especially that at least in a simple approximation, the light modulation values are independent of light modulation properties. This allows in particular the separation of the process into two steps in accordance with the invention.

All light modulator types in connection with the light modulation values which they can assume, define a color space of the light modulators in which the light modulation of the medium can be taken into consideration.

In the modeling of the answer of the image reproduction system model onto incoming image control data, the amount of all permitted (realizable) image control data span a light modulation color space of the light modulators. The latter can be related to the image control data or also the color space of the input images. The modulation strength of the light modulators which is fixed by the image reproduction system in response to the image control data and reproduced especially by the light modulators hereby has particular importance. The modulation strength is, for example, determined by the amount of pigment in the photographic paper.

The model in accordance with the invention describes especially a system made of an image reproduction device and a medium, which system produces an image by way of pigments (light modulators). A relationship between image data and light modulation values is thereby preferably produced by way of the reproduction properties of the system. A relationship between the light modulation values and the reflection color values (commonly: “modulation color values”) is established by the light reflection properties (commonly “light modulation properties”) of the pigments. The invention relates to any use of this model, especially processes, devices and programs which use this model. The pigment control values (light modulator control values) describe the production of pigments (light modulators) with specific light modulation values by the image reproduction device in or on a medium on the basis of the image control data. The reflection color values (modulation color values) describe the visual appearance (or measured by a color measuring apparatus) of the photographic image represented by the medium in a preselected color space. For the calibration of the model, modulation color values are preferably calculated which are measured by the color measuring apparatus used for the calibration. Additionally or alternatively, the produced colors can also be spectrally measured and the spectra with the sensitivity curves assigned to the modulation color values can be folded.

The image control data which are used for control of the image reproduction devices can be, for example, RGB image data, which represent the photographic image. These image control data are preferably obtained by digital scanning of a photographic film or originate from a digital photographic camera or are transferred through a network or stored on a storage medium. The image control data generally describe the image in a color space which is suited for auto-luminous image reproduction devices, such as, for example, monitors. In particular, the image control data are described by sRGB. These image control data must then be converted within the image reproduction device which, for example, uses light reflecting pigments, in a suitable way for the control of the color production or the light modulation.

The production of image control data by way of the scanning of films is described, for example, in the European Patent Application No. 001 04 491.6 with a title “Optimierungsapparat fηr fotografische Bilddaten” (optimization apparatus for photographic image data). The processing of the image control data (there referred to as “image data”) is described therein for the removal of film type specific or camera type specific properties of the image data. The control of the image reproduction device is then carried out on the basis of those “optimized” image data.

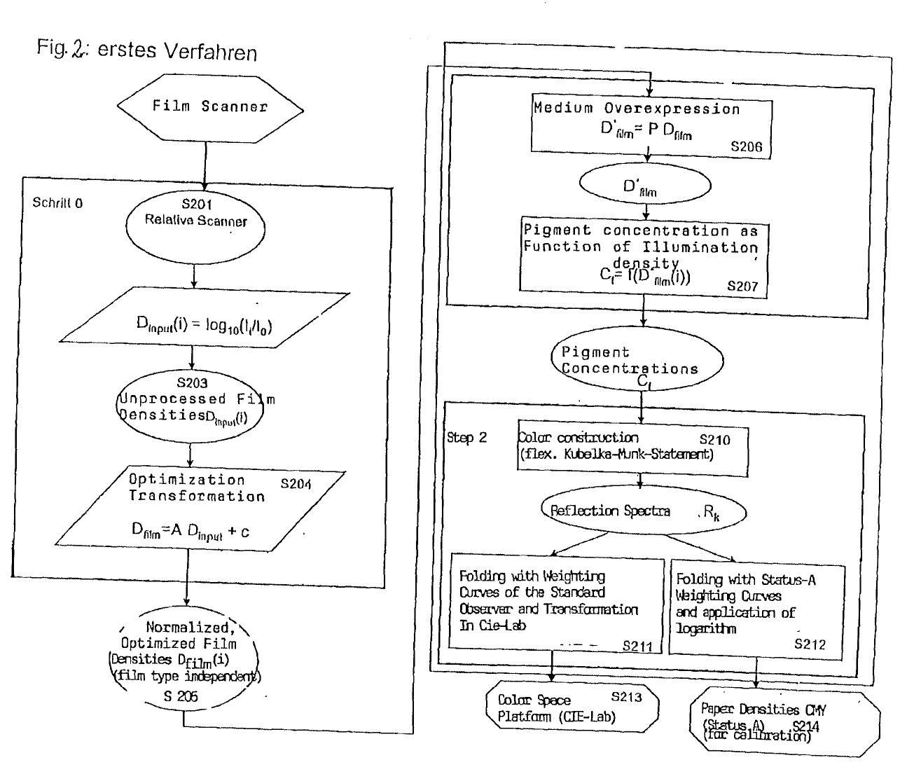

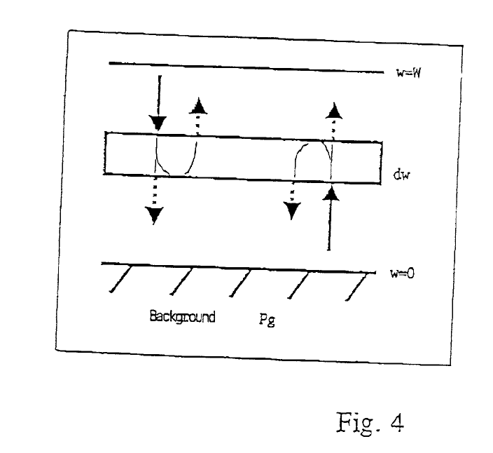

In accordance with the invention, it is now modeled according to the first process (compare steps 1 and 2 in FIG. 2 and “paper model” in FIG. 5) how an image produced by an image reproduction system (pigment system) would appear based on the input image control data (for example “optimized image data”). How the image would appear (for an observer or an measuring apparatus) is described by modulation color values. One starts, for example, with a model image reproduction device and a model medium.

In the first step, the light modulation values are calculated which describe the light modulation by the light modulators (pigments) in or on the model medium. The image reproduction device converts the incoming image control data into light modulator control values. A dynamic adaptation to the reproducible luminescence range is thereby especially carried out. The light modulation values of the light modulators are determined by the light modulator control values which are exemplary referred to in the following as pigment control values. If the medium is, for example, paper and an inkjet printer, the pigment control values control the ejection of the pigments from the jets of the printing head onto the medium. If the medium is, for example, light sensitive photographic paper, pigments are produced in the medium (for example in transparent, surface adjacent layers) by illumination of the medium. The pigment control values control in this case the color and intensity of the illumination light and thereby the color (complementary to the illumination light) and amount and/or concentration and/or layer thickness of the pigments produced and therefore the light modulation by use of the pigment. The light modulator control values are determined by the image control system from the incoming image control data in order to achieve a most realistic reproduction of the image information contained in the image control data by the light modulators. In a direct model, a direct relationship between the image control data and the light modulation values can be assumed without a detour via light modulator control values. If corresponding light modulation values are now calculated in a first step (or image control data), one can calculate in a second step how the image appears to an observer or a measuring apparatus. Modulation color values are herefor determined (for example “reflection color values”), which describe the color values of the light modulated by the medium for example “reflected light”. The light modulation color values are in the following exemplary referred to as reflection color values.

The relationships between (image control data and) light modulation values and reflection color values are preferably determined by optical measurements.

The pigment control values are dependent from the image control values. The production of the pigments on the basis of the pigment control values, which means, for example their concentration, amount and/or spatial distribution, depends on the pigment production properties of the pigment system. The pigment production properties describe the answer of this system to the pigment control data during the production of the pigment. This can also be modeled and/or empirically determined on the basis of known properties of the image reproduction device or the medium. For example, it can be empirically determined which incoming image control data lead to which concentrations and/or amounts of certain pigments. The different types of pigments which are available for the reproduction of the colors must hereby especially be considered. The determination of the concentration and/or the amount can be carried out, for example by optical measurement of the color saturation of pure (non-mixed) pigments which are applied by the image reproduction device in different concentrations onto a medium in the form of a test field. A relationship between color saturation and image control data results, for example, from a clear association between image control data and the test field. One can then infer the relationship between image control data and pigment concentration (light modulation value) directly or on the basis of the known spectral properties of the pigment. The produced pigments (as well as a medium) have light modulation properties such as, for example, (spectral) light reflection properties, light absorption properties, and/or light transmission properties, which are in the following exemplary referred to as “light reflection properties”. They depend on the pigment color or the chemical and physical composition of the pigments, the concentration of the pigments, the spatial distribution of the pigments (positioning in a higher or lower layer) and/or the amount of pigment, and so on. The light reflection properties and/or light absorption properties of the pigment produced can however also be modeled. For example, the reflection spectra of the individual pigments can be measured or modeled depending on their concentration or thickness in or on the medium, and the data obtained can then be used as light reflection properties in the model.

The system platform colors pace is preferably a standard color space. A color space is particularly preferred which is adapted to the color recognition of the human eye. A color space is also preferred which describes the reflection properties of the medium as far as they are not changed by the pigments. Especially preferred is the CIE-Lab color space.

The reflection color values are also calculated from given emission properties of a light source which illuminates a model medium. The emission properties describe especially the spectrum of the light source and/or the illumination geometry (for example the emission angle and/or the direction of illumination relative to the medium) and/or the illumination strength (brightness of the light source). The emission properties describe in particular the properties of the illumination light source which influence the color impression of an absorber by way of the reflection by the medium or pigments.

The platform in accordance with the invention is determined by the color values which are present in a specific color space, the illumination (spectrum of the illumination, intensity) and the illumination geometry (aperture angle). Therefore, in the platform in accordance with the invention, less data are present than if one used, for example, spectra as platforms. Furthermore, the platform is already adapted to the properties of the image reproduction system model which is close to reality. The model in accordance with the invention is thereby preferably designed such that all information which can be processed by real image reproduction systems can be processed in the platform. This applies especially when in the model in accordance with the invention ideal properties are assumed for the light modulators and possibly the medium. An essential advantage of the invention described herein resides in this idealization. In this manner, no information is lost which later could be represented by an image reproduction system of any construction. Nevertheless, an approximation to the reproduction properties of the real image reproduction systems takes place. In a second process, which will be described in the following, an adaptation to an ideal image reproduction system can be carried out specifically by a “deterioration” of the color values. The above represents an essential difference to the prior art in that from the beginning a most exact adaptation to a real system is attempted, for example, by black box mapping. In this approach in accordance with the prior art, an adaptation of the system to other real image reproduction systems, for example, upon a change of the image reproduction system, is very difficult, since in the first carried out black box transformation which was adapted to the first real system, information was already lost which could have been used by the second real image reproduction system. With the platform principle in accordance with the invention, which within a framework of a first process uses an idealized model for an image reproduction system, this disadvantage is removed and a flexible adaptation to real image reproduction systems is made possible because of the platform in accordance with the invention.

Connections between image control data (RGB values) and light modulation values (for example, pigment concentrations) are first experimentally produced. Image control data are therefore, for example, input which only (or mainly) contribute to the production or excitation of light modulators of one specific type. For example, RGB (0:1:1) only one pigment cyan is produced by a printer. This pigment concentration is then varied by a change of the image control data, for example, from no pigment to full pigment concentration. This is carried out for all light modulator types in order to generate a relationship between image control data and light modulation values. The light modulation properties of the light modulators, for example the spectra of the pigments, can be measured, for example, with a spectrometer. This can also be carried out for each light modulator type depending on the light modulation value, i.e., for example, depending on the pigment concentration. The light modulation properties of the light modulators are thereby known. They can then be used in the model, for example, after an idealization, which for example clips the spectra in order to limit over expression. The test printouts can be measured by color density measuring devices, which, for example, deliver ANSI-A-values and therefore have a specific sensitivity for certain colors. Preferably, test Grey fields are used as test printouts which use all light modulators in order to produce the color grey at different brightness levels. The test grey fields are then, for example, measured with a measuring instrument, in order to determine a connection between ANSI-A-values and the light modulation values. It is an essential peculiarity of the model that the physical property of the image reproduction system, namely the use of different types of light modulators with different light modulator properties is entered as knowledge into the model in order to thereby make the mathematical concept more easily adaptable to the different real parameters (for example upon change of a light modulator type). It is essential for the model that one starts with light modulation values which embody the real physical properties of the image reproduction system. The values used in the prior art, such as, for example, RGB values, represent artificial color systems, which are not correlated to the image reproduction system. By transformation of these “artificial” values into light modulation values, a better basis for a modeling is created which then in the end delivers a flexibly adaptable model with excellent properties.

If one knows the light modulation properties (for example spectra) of the light modulators, the light modulation values can be determined from the measured data, for example, of the color densitometer and the known sensitivity curves of this measuring instrument. Correspondingly, one can then determine the light modulation values from the measured spectra of test fields. For example, one can calculate from the light modulation values and from the known spectra for the light modulators above the LAB values which, for example, are perceived by the human eye at a specific illumination. The illumination geometry and the properties of the illumination source are preferably also taken into consideration for the determination of the light modulation values from the measurements taken with the color densitometer.

When the above mentioned grey fields are used, a direct correlation exists, for example, between the values of the light modulators and the vector L in the LAB illustration. Thus, the model can be calibrated by calibration of the grey scale.

The interactions of the light modulators during the reproduction of an image can be taken into consideration by suitable functions and transformations. Preferably, the properties of the individual light modulators which influence the image appearance are considered independent of one another in the model described herein. This applies especially for the 0 approximation. In first approximation, properties of the light modulators which influence one another can be taken into consideration, for example, by interference calculation. For example, the over expression of the spectra of the individual pigments (light modulators) can be taken into consideration, for example, through matrixes, or also when different color layers overlap one another.

The advantage of the model of mutually independent light modulators resides in the possibility of the linear combination of, for example, spectra.

The correlation between light modulation values and the color values, for example LAB values, is achieved as follows, for example. Light modulation properties (for example spectra) are assigned to the individual light modulators (for example pigments) which were, for example, determined by measurement or, for example, are known for certain pigments. The light modulation values represent a type of weighting factor of the light modulation properties. Through a transformation, the light modulation properties are transformed for each light modulator into transformed light modulation properties. The light modulation properties are now present in a transformed space, which has the property that it is suitable for a combination of the light modulation properties of different light modulator types. The transformation is, for example, a Saunderson transformation with a following application of the logarithm. The combination of the transformed light modulation properties (for example, transformed spectra) then occurs preferably linearly and eventually with the application of corrections (for example by way of interference calculation). A retransformation is then again carried out in the actual space of the light modulator properties (actual space of the spectra). The now found light modulation property (the now found spectrum) represents a combination of the light modulation properties of all light modulators. The light modulation color value can then be determined from this combined light modulator property. The type of the light source and the illumination geometry are thereby preferably also considered. Since the above mentioned transformations are reversible, an approach in the opposite direction is possible. This is described in the following in connection with the second process. However, in the first process, other light modulation properties (idealized light modulation properties) are used as the basis for arriving at a suitable platform. More real models are then used as the basis for the second process in order to achieve a good adaptation to the actually used image reproduction system.

The properties of the medium (for example color tone of the paper) can be taken into consideration, for example, as a separate light modulator type or upon the combination of the transformed light modulation properties. This can also be carried out in the form of a correction.

It is an important advantage of the invention that upon, for example, the use of light modulators with principally known light modulator properties (for example use of known pigments) an adaptation of the system to a real image reproduction system can be carried out with good results by measuring a few fields, for example, grey fields. It is thereby especially used, in contrast to the black box model, that at least approximately the modulation strength of the light modulators which depend from the image control data and are described by the light modulation values are independent from the spectral modulation properties which depend on the light modulator type and are described by the light modulation properties.

A second process (compare “inverted paper model” in FIG. 6) in accordance with the invention is described in the following, which uses the same model but is carried out inverse to the first process. In other words, the input data of the first process are the output data of the second process and the output data of the first process are the input data of the second process.

The second process relates to the modeling of image data which lead to the production of a preselected photographic image (photo image) when a model image reproduction device is controlled based on the image control data in order to produce the image in or on a model medium. The image control data of the first process can, for example, be different from the image control data of the second process with respect to representation and color space used.

In a first step, the light modulation values are calculated which must form the basis of the reflection color values (modulation color values) for a given system (a given model reproduction device) and a given illumination of the medium or a given light reflection (light modulation property) of the pigments (light modulators). Especially considered is thereby the (spectral) emission property of the light source illuminating the medium or the image. The light modulation values (for example given by the concentration of the pigments or the degree of polarization of a liquid crystal or a function thereof) for given pigment species or types can be calculated from the reflection color values, the illumination and the (known or measured) spectral light modulation properties (light reflection properties of the pigments, for example). This calculation is based on the spectral light reflection properties of the pigments and especially the type of the available pigments or the colors (for example cyan, magenta and yellow) producible by the pigments. For example, based on the light reflection properties for a given group of pigments, each pigment is assigned a certain modulation intensity or modulation strength (concentration), which is represented (simplified) in the model by a light modulation value. The modulation strength or intensity of the pigments is dependent especially on the concentration or density of the pigments. Normally, the higher the concentration, the more saturated the color which is produced by the light reflected by the pigment and the stronger the light is modulated. The modulation properties (modulation strength and spectral properties) are also dependent on the spatial distribution of the pigments, i.e., whether, for example, further pigments are positioned above or below a pigment. In that case, the absorption and transmission properties of the other pigments also play a role, for example. Finally, the layer thickness, the sequence of the pigments and the amount of the pigments can also be taken into consideration for the light reflection properties, which, for example, can also be influenced by the overlapping different pigments. As already mentioned above, the light reflection properties of different pigments can be determined, for example concentration dependent, by optical measuring. The values so obtained then flow as light reflection properties into the process in accordance with the invention.

Furthermore, the relationship between the pigments and the light modulation values are preferably modeled, or the relationships empirically determined or measured. For example, test images are produced from a system to be modeled or from a multitude of different systems, which initially cover the majority of the reproducible color space. A model calculation can be based, for example, on the pigment production properties given for the system of image reproduction device and medium, which describe the production of the pigments in response to the image control data.

When the light modulation values are determined from the reflection color values, image control data corresponding to the light modulation values are calculated in a subsequent step which upon input into the model image reproduction device lead to the production of the image.

When the light modulation values are determined from the reflection color values, image control data corresponding to the light modulation values are calculated in a subsequent step which, upon input into the model image reproduction device would lead to the generation of the image.

Upon the transformation of the image control data into light modulation values and therefore also upon the transformation of the light modulation values into corresponding image control data, one must take into consideration that the image reproduction system (in the following exemplary referred to as “pigment system”) has other color properties or modulation properties than the system from which the image control data originate. In particular, the color space of the photographic image data (which, for example, originated from a film) is typically larger (larger dynamic grange, larger gamut) as the color space or gamut which can be reproduced by the light modulators (in the following exemplary referred to as “pigments on a medium”). In other words, the modulation strength of the light modulators is not sufficient to represent the full dynamic. Thus, upon transformation of the photographic image control data into light modulation values, the reproduction properties of the pigment system must be taken into consideration. These reproduction properties thus represent a relationship between the color space reproducible by the pigments and the medium and the color space describable by the image control data. The production properties of the pigment system thus describe, for example, the adaptation of the dynamic range of the image data to the dynamic range reproducible with the medium. Typically, the dynamic range of the photographic image data which are obtained, for example, by way of a camera, are magnitudes larger than the dynamic range reproducible with a medium provided with pigments and illuminated.

The production properties preferably also describe an over expression of the colors or spectra of the different pigments.

Upon illumination of the photographic paper, two types of over expression come to bear. Upon illumination, a specific color layer (for example the yellow pigment) is excited not only by light of complementary color (for example blue color). This type of over expression is however in the case of photographic paper normally negligible and is therefore preferably not modeled (in step 1). The second type of over expression comes to bear during the measurement of the developed image. Each pigment absorbs not only light in the wavelength region of “its” color, but also in wavelength regions of other colors. This over expression is not negligible and is preferably taken into consideration during the calculation of the modulation values (in step 2) in that the spectral modulation properties of the light modulators are taken into consideration.

The color tone range or gamut which is reproducible with the pigment system is typically smaller than the color tone range or gamut reproducible by the input image control data, or not congruent. Thus, an imaging or transformation of the non-reproducible colors into reproducible colors must be carried out. This adaptation can also be described by the production properties (within the framework of step 1).

The first above mentioned process, which produces reflection color values, is preferably presumed to be an ideal pigment system (model reproduction system). This ideal pigment system has, for example, a larger dynamic range than is reproducible with real systems, a larger color tone range (gamut) than is reproducible with real systems and shows, for example, no over expression or only minor over expression of the first type. The ideal pigment system is thus preferably designed so that it encompasses the production properties of all the real media (all media considered for an application) or image reproduction devices which use pigments. In other words, independent of the type of image data, the ideal modulation color values (reflection color values) of the ideal model represent the image data better than any real pigment system. The ideal pigment system also has ideal production properties, that is preferably guided nevertheless by the principle limitations of a passive, non self-illuminating photographic image representation by medium and pigment.

Otherwise, in contrast to the common, device dependent platform of the ICC standard, the model image which is produced according to the first process and represented by the reflection color values, is preferably typical for the presentation of an image with pigments in or on a medium. The production properties are also selected so that all real pigment systems can be represented without going significantly beyond the properties of the real pigment systems. The reflection color values which were produced according to the first process of the invention, are optimally suited as starting point for the calculation of image data used for the control of a real pigment system of medium and image reproduction device. Thus, they take into consideration all the essential differences between a pigment system operating with pigments and an active system which produced the colors with self-illumination such as, for example, monitors. Especially, the maximum possible dynamic range of the reflection color values is significantly smaller than the dynamic range producible by the inflowing image data (for example, by one order of magnitude smaller or more). Accordingly, the reproducible color tone range is also significantly smaller, for example, than the color tone range reproducible by the image data.

When the reflection color values, for example, are again transformed into image data for the control of a monitor, one can observe on the monitor which result is maximally or ideally achievable for given image data with a system of an image reproduction device and a medium.

Image control data for control of a pigment system of image reproduction device and medium can be achieved by serial connection of the first and second process whereby the models respectively forming the basis for the image reproduction system are preferably different. The reflection color values present in the desired color space after execution of the first process represent the interface (platform) between the first and second process. An idealized model of a pigment system of medium and image reproduction device is thereby preferably used as the basis for the first process, while for the execution of the second process a real model of a pigment system of real medium and real image reproduction device is preferably used which is actually controlled by the image data calculated by way of the second process. Optimally adapted image data for the control of a real system can thereby be produced through the detour to the ideal reflection color values.

The invention further provides a program for carrying out the processes in accordance with the invention by way of a computer, as well as a storage medium with the computer program.

The invention further provides a printer having a control unit which processes the input image data according to the second process representing the properties of the medium used by the printer.

The invention additionally provides a printer which includes a control unit for processing the input image control data first according to the first process with an ideal model and then according to the second process with a real model which reflects the properties of the printer and the medium used by the printer.

The invention also provides a film scanner for processing the scanned color data only according to the first process or first according to the first process and then according to the second process.

The invention further provides a photo lab, especially digital minilabs or a printer or a scanner for a large scale lab wherein one or both of the processes are used.

The invention further provides a photolab, especially a so called minilab or large scale lab. Such photolabs or photographic minilabs process photographic image information in order to then output it in different format after the image processing. For example, the processed image information is output on a medium, stored on a data carrier or output through a network. The image information can be digitally input, for example, by way of data carriers used by digital cameras, or classically through films which are then optically scanned, in order to digitize the input image information before further processing. The invention provides such photolabs or minilabs which include a control device or a computer which carries out at least one of the processes in accordance with the invention or uses the model in accordance with the invention. It also provides a photolab, especially a minilab, which uses at least one printer of the above described type. The processes in accordance with the invention are also applicable to produce, for any real system made of an image reproduction device and a medium, optimized image data for the control of the real system which take into consideration the properties of the real system. Test images produced by a real image reproduction device on a real medium are herefor received which preferably describe or cover the dynamic range, the color tone range and/or the over expression properties. Further received are digital image data which represent an image to be produced with the real system. These digital image data are then optimized for the real system by a sequence of the first process and the second process. Modulation color values (in the following exemplary referred to as “reflection color values”) are herefor preferably produced with the first process, whereby an ideal system is preferably used as the basis herefor. The optimized image data for the control of the real system are produced from the “ideal” reflection color values. The test images are thereby optically measured in order to determine the production properties required for the execution of the process and the relationships between the light modulation values and the reflection color values.

The invention also provides a use for the model described herein in devices, processes, programs and business models.

An embodiment of the present invention will be described in the following by way of example only and with reference to the attached drawings, wherein.

FIG. 1 shows the networking of a photographic lab with input devices and output devices;

FIG. 2 shows the application of the first process in accordance with the invention (step 1 and 2) with proceeding step 0;

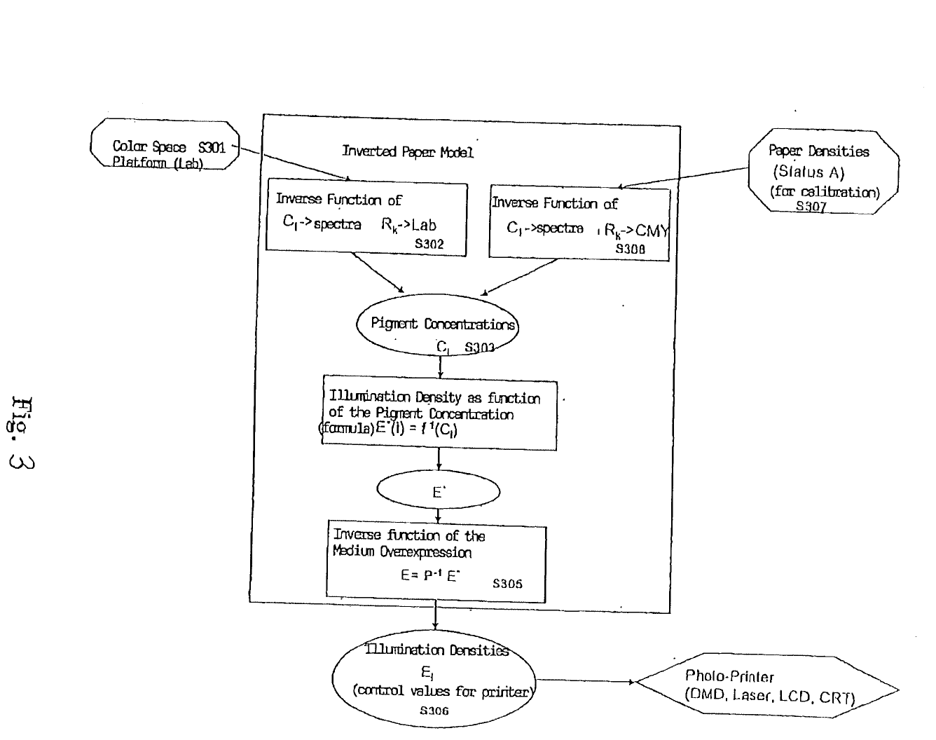

FIG. 3 shows the second process in accordance with the invention according to the embodiment of FIG. 2;

FIG. 4 illustrates a reflection model for a light sensitive medium.

### DETAILED DESCRIPTION OF THE PREFERRED EMBODIMENT

FIG. 1 shows a schematic view of a color management according to the invention, in which a desired color space or standard space serves as common platform in the middle. The CIE-Lab color space is preferably used as the standard space. It has desired properties, namely that it is independent of the type of the pigment system which operates with an image reproduction device, pigments and a medium and covers all color spaces of all possible pigment systems. The color data of a specific image which are represented in the color space are not completely independent from the type of the devices which were used for the capturing and digitalization of the image information (for example, camera, film scanner), since the details of an image represented in this color space show the color tone range or gamut of these input devices, since different input devices typically clip or distort different portions of the color space. However, as preferred and important property, the color space is designed so that each color takes up its own, well defined position or unique region in the color space. Preferably, further defined transformations exist between the color space and the different input or output devices. Output devices are, for example, pigment systems, monitors, digital storage media or network interfaces.

Preferably, that CIE-Lab color space is used which has the following advantages or a color space with the same or similar advantages.

The CIE-Lab color space is adapted to the color sensitivity of the human eye. In the lab color space, each color pair which is separated by the Euklidic distance I, is spaced equally far from one another for a human observer. An average observer is thereby able to differentiate colors up to about) E=[( )L²+)a²+)B²)]^{½=1}

The brightness L is separated from the chromatic information (color tone and saturation). The radius [(a²+b²)]1/2 in the (a,b) plane is a measure for the color saturation. The angle with the a-axis is a measure for the color tone.

A further advantage of the CIE-Lab color space resides in that it is not limited to a specific color range or gamut. This is, for example, a difference to the sRGB color space, assuming one also allows negative sRGB values.

Software programs are known for the determination of transformations from the Lab color space into an RGB color space. A user must therefore generally input a test chart or a test printout with the Lab data into an input device (for example scanner). The Lab data are optically measured (for example spectrometer) and the response of the input device is output, for example, in device specific RGB data. By comparison of the output RGB data with the original Lab data, it is possible to produce a reference table which allows the transformation from the Lab space into the RGB space.

The data flow for the image data captured with the film scanner up to the CIE-Lab color space is discussed in the following with reference to FIG. 2. In a step 0, the data of a film (negative film) determined by a scanner are processed and treated to make them independent of specific film properties. The film type independent data so obtained are converted in a step 1 into a pigment concentration.

In a subsequent step 2, final CIE-Lab values are predicted for a given printer input based on the pigment concentrations. These values correspond to the reflection color values. The combination of steps 1 and 2 represents a model of a medium (for example photographic paper). In addition, paper densities CMY can also be calculated as they would be measured by a densitometer. The steps are generally carried out in detail as follows. The scanner for negative films scans the fixed negative film. The scanner thereby illuminates the negative with a light source and obtains an intensity relationship between a reflected intensity flow which is reflected by the film and an incident intensity flow from the light source. These relationships are measured, for example, by way of three filters, red (I=1), green (I=2), and blue (I=3). The returned values of the scanner are coded as RGB intensities of the negative. If the image includes a strongly saturated green, for example, the scanner would return an RGB vector for magenta (namely about 1, 0, 1).

The RGB intensity relationships Iᵢ/Iₒ are converted into RGB film densitites, whereby the formula Dᵢₙₚᵤₜ (i)=aᵢ log₁₀(Iᵢ/Iₒ)+bᵢ is used (S202). For an ideal system, the values aᵢ=−1 and bᵢ=0 would result.

A so called Eye-Tech-Correction optimization transformation can be carried out in a subsequent step (S204) as described in European Application EP 00104 491.6. This Eye-Tech-Correction can be represented, for example, as a 3×3 matrix A, a three-dimensional vector c and a three-dimensional vector d (x), which is dependent on the position x in the image. This is carried out in step 204 of FIG. 2. The corresponding formula is as follows:

D_{film}(i)=ΣⱼAᵢⱼDᵢₙₚᵤₜ)+cᵢ+dᵢ(x), wobei i,j=1, 2, 3

The matrix A essentially removes a color trend during the grey graduation, preferably by a suitable rotation transformation, shearing and/or stretching. Analog systems do not have a feature corresponding to the matrix A, since in analog systems only the exposure times can be changed by the three filters red, green and blue. Thus, an analog system, in contrast to a digital system, can not selectively change specific colors. The three dimensional vector c corresponds to the illumination factor of the three filters RGB. Since the densities are defined as the logarithm of the intensities, the illumination factors appear as additive constants. The vector d (X) carries out the local density correction and modifies the RGB illuminations as a function of the position in the image. The RGB data mentioned herein are purely exemplary. Of course, other color spaces can be used for the representation of the data. The optimization transformation carries out the optimization in that the image data to be optimized are transformed into another color space which is suited for a color correction (for example by way of rotation).

The Eye-Tech-process or optimization process described in EP 00104 491.6 leads to normalized film densities D_{film} (i), which are centered around 0 and have values typically in the range of (−0.5, 0.5). From time to time it occurs that D_{film} (i) is also located outside this range. The film densities D_{film} (i) are independent from the specific film properties at the end of the Eye-Tech-process. Their mask was removed and the grey scale was corrected based on the spectral information from the individual image and stohastic data on the image. The data D_{film} (i) are normalized, modified film densities with respect to a common film without film mask which are expressed, as RGB densities of a negative (S205).

Instead of the process illustrated in step 0, another process can also be used in order to process image control data before they are used for the model of a medium in accordance with the invention. The film data can also be subjected to a classification in a step 0 (in S204) which leads to an image type dependent manipulation of the image data. For example, the brightness of certain regions of the image can be manipulated or the color distribution carried out differently depending on the image type (for example, lots of blue sky). Of course, one can also leave out S204.

The above mentioned local density correction is one of many possible image improvement algorighms such as, for example, contrast improvement, red eye removal, scratch removal and so on. Such image improvement algorighms are preferably used at two locations, in the color density space, as was described above in connection with the local density control, and in the platform space, for example, the CIE-Lab standard color space. Data independent image processing procedures are preferably used in the platform space such as, for example, softener and red eye removal.

The steps 1 and 2 described in the following represent an example for a model in accordance with the invention for a medium. One thereby starts from a light sensitive medium which is illuminated, for example, by way of a DMD. The illumination system would expose the medium (for example paper) in the ideal case, for example, with red, green and blue light. Each of these latent images would be produced only by the medium pigment (for example paper pigment) of the corresponding complementary color or generated by optical excitation in the light sensitive medium, for example. The red image would cause only a cyan image on the paper without any other pigment being influenced or produced thereby. In a similar manner, a green image would only lead to a magenta colored image on the paper (or in the paper) and the blue image would generate a yellow image.

An over expression of the medium takes place with strongly saturated colors. For example, an overly long exposure by a blue filter also leads to a certain amount of cyan pigment and magenta pigment, apart from the desired yellow pigment. If the exposure is sufficiently long, the yellow pigment has reached its saturation limit, whereby the other colors cyan and magenta are still in the linear range until they finally after a very long exposure also reach saturation.

In the following illustration of the first step of the medium model in accordance with the invention, it is assumed that the system of film and media is well adapted which is true in the ideal case for an analog printer. This means one assumes that no additional changes of the density (for example local density control) are necessary. Such changes or classification dependent changes can, as already discussed above, be carried out already in a step 0 or can be inserted at a suitable point in the following steps 1 and 2. However, this is not discussed in further detail.

The inventors have discovered that over expression effects up to the first order can preferably be neglected so that, for example, the following 3×3 standard matrix P can be used for describing the over expression,

$$P = ( \begin{matrix}1 & 0 & 0 \\ 0 & 1 & 0 \\ 0 & 0 & 1\end{matrix} ) und {D}_{film}^{*} ( i ) = {\sum }_{j} {P}_{ij} {D}_{film} ( j ) , i , j ∈ \{ 1 , 2 , 3 \}$$

One can of course also model the over expression (up to higher orders). For example, one can introduce in the above matrix P elements other than diagonal elements which are dependent on the film density. Better results for strongly saturated colors may be achieved thereby. If the other than diagonal elements of the matrix are filled with values other than 0, those values are however, presumeably significantly smaller than the diagonal values. It is noteworthy that a matrix P serves the modeling of an undesired over expression of the film paper system. The matrix P does not take into consideration unintentional over expression (for example all coupling layers located between the layers) which serve the compensation of disadvantages of the light sensitive paper (at least as long as the over expression increases linearly). These properties represent inherent properties of the film paper system the properties of which should preferably not be modified.

If the medium over expression was taken into consideration in a step S206, the transformation of the film densities D*_{film} (i) into, for example, CMY pigment concentrations Cᵢ, i=1, 2, 3, is carried out in a subsequent step S207. The film densities have a relatively flat profile as a function of log₁₀ (Tₑₓₚ) whereby Tₑₓₚ represents the exposure time. However, they cover a wide range of log₁₀ (Tₑₓₚ). This leads to a negative film being very tolerant to over exposure or under exposure. A medium, for example, photographic paper compensates this flat profile and compresses the upper and lower ends of the log₁₀ (Tₑₓₚ) scale with the use of a characteristic medium function, which typically has an S-shaped form.

The above mentioned medium functions serves the transformation of film densities D*_{film} (i) into CMY pigment concentrations Cᵢ, whereby i=1 signifies cyan, i=2 signifies magenta, and i=3 signifies yellow. The S-shaped function can be described, for example, as Tanges Hyperbolicus.

The step 2 shown in FIG. 2 is described in the following. The pigment concentrations describe the light reflection properties of the pigment produced. With a set of n pigment concentrations Cᵢ a resulting reflection spectrum R(8)d(8) is derived, whereby the Kubelka-Munk statement with a single constant and with a simplified Saunderson-Correction is used. This statement is described in Kang, H. R. (1997 a), 2.6 Kubelka-Munk theory in: Color Technology for Electronic Imaging Devices, SPIE Optical Engineering Press (Washington, USA) pages 48-54. The model of Kubelka-Munk represents only one possible realization. A further possibility consists, for example, in a simple model in which a linear correlation is produced between the spectral color concentrations and spectral color densities. This model can also be expanded with the Kubelka-Munk statement, for example, into a three color layer model. Finally, at the end of the second step, the reflection spectrum R(8)d8 is weighted with the relative spectrum of the illumination source, for example, (D₆₅, 2E) and folded with color tuning functions of the CRE-XYZ-space (S211). The resulting CIE-XYZ-triplet is converted into Lab-values, whereby the standard formula and the white point of the paper or medium is used. Further properties, especially of the medium, can also be taken into consideration especially within the framework of step 2, which influence the properties such as, for example, whether the medium is glossy or matte. Different reflection spectra or model parameters, for example, can be selected accordingly.

The model calculates resulting Lab values for a mixture of n pigments. It is thereby differentiated between printer-RGB-input data and pigment concentrations Cᵢ. All values are normalized to 1 and lie in the interwall [0,1]. The index I runs once from 1 to n.

ANSI status-A paper densities or other color density values which would be measured by a photodensitometer can be calculated from the spectral reflection spectra, and that by folding with the corresponding color tuning functions.

The input pigment concentrations which are necessary for the model and serve the description of the light reflection properties of the pigments, are referred to as Cᵢ. They represent the weighting factors for the pigment i in the model. For example, the reflection of a light of a specific color is the lower the higher the pigment concentration Cᵢ. The concentration Cᵢ always shows how much color is necessary from the “color pot” with the number i in order to achieve the desired result. The different pigment concentrations Cᵢ are modeled pigment concentrations and mainly represent a mathematical construct. They farther represent an example for the description of a light reflection property, which describes the strength of the light reflection for a specific color.

No upper limit exists for the number of pigments, however, at least three independent primary colors are preferably used. A primary color cannot be achieved by mixing other colors of the color set of primary colors. Since the eye is equipped with three independent color sensors (red, green=brightness, blue), each complete description of the color space requires at least three primary colors or base colors. The printer-RGB-input data represent such a minimal system of basis colors. The set with C, N, Y represents a typical selection of a color basis system for a photographic paper or medium. A DMD printer preferably carries out an illumination with three colors L, G and B, which then lead to the complementary colors C, M and Y. The inventors have discovered that the model in accordance with the invention leads to good results already for three primary colors. Especially good results are achieved when colors with two different degrees of saturation are used as the basis for the model. To increase the precision of the model, one can insert more pigment points or interpolation points into the color space in order to achieve a more exact adaptation to the measured values.

A DMD printer is preferably calibrated for the measuring of color spots or color test fields, whereby the color test fields describe color values which lie on the grey axis and reach from white to black. A measure for the S-shaped dynamic curve results therefrom which describes the illustrated color density as a function of the exposure time with a defined exposure color. It is assumed from this color density of the medium that it is a function of the pigment concentration. Since the herein described pigment concentrations are only valid for a model, i.e. are “model pigment concentrations”, they can be set simply as directly proportional or equal to the medium color values achieved for a defined exposure color. It is thereby assumed, for example, that the defined exposure color only produces a specific pigment type. The color densities of the medium are herein also referred to as paper densities, since photographic paper serves as medium, which is exposed by the exposure light. For the measuring of the color density of the medium, one can use a densitometer, for example. For a CIE standard observer, a D₆₅-light source with an aperture angle of 2E is assumed.

In the first as in the second process, the model can be calibrated as follows. The shape of the saturation curve is determined such that a given set of input image control data (input data), which is transformed with the model, corresponds best possible with an associated set of reflection color values (output data set). A set of color values is sufficient therefor which for selected colors, for example, CMY, density wise varies from the minimum density to the maximum density (for example 10-32 values). Different descriptions are possible for the saturation curve, for example, a tauh function with two parameters x0, b: y=tauh ((x−x0)*b); a function similar to the tauh function with 2 to 4 further parameters, which describe a possible assymetry of the function; and a partially linear function with typically 18 to 32 interfaces. The first and last mentioned function for the adaptation of the dynamic range of the image control data color space to the dynamic range of the light modulators is preferred for the above described embodiment, whereby the first function would do with very few color values to carry out a calibration, whereby the parameters are determined by a linear regression. In the case of the third function, it is built directly from the input and output data.

The input data of the data set in the first process are, for example, normalized film densities D (J) which were measured on test patches of a negative, or digital RGB image data which are intended to be input into the printer. The output data for the first process are, for example, the desired paper densities CMY (j) (reproduced, for example, such as an analog exposure of the test negative) which possibly covers the reproducible color density bandwidth for each pigment of the system.

In the second process, the control densities E (J) (for example RGB control values for the control of a printer) preferably serve as output data set for the production of a set of test patches and measured paper densities CMY (J) of test patches as input data set, which were produced with the control densities E (j) This set of control densities E (j) is thereby preferably iteratively adapted so that at the end of the calibration, when the desired paper densities are achieved (for example grey values from D min to D max of the colors C, M and Y).

The calibration can also be made starting from the CIE-Lab, but the calibration with paper densities CMY is preferred.

FIG. 3 shows the inverse paper model corresponding to the FIG. 2 wherein the inverse steps to the steps S207, S208 and S209 are also combined. The exposure densities described in step S304 are again the pigment control values.

As is apparent from FIG. 2 (S214) and FIG. 3 (S307), not only the color space platform (S213, S301), but also the paper densities (S214, S307) can mediate between the paper model and the inverted paper model. The paper densities represent a special example for a color space platform.

The calculation of a reflection spectrum according to step S210 is described in the following. The Kubelka-Munk theory with a single constant (single constant Kubelka-Munk theory) is used for the calculation. The Kubelka-Munk statement is used to produce reflection spectra R(8)d8 for a given set of pigment concentrations Cᵢ. The reflection spectra R(8)d-8 are weighted with a normalized, relative spectrum R(8)d8, whereby the relative spectrum is standardized as follows:

∫Γ(λ)dλ/∫dλ=1

The light source has given properties such as, for example, the D₆₅ light source. The weighting is carried out as follows:

R′(λ)dλ=R(λ)Γ(λ)dλ

Thereafter R.(8)d-8 is folded with the coordination functions (color sensitivity curves) of the CIE-XYZ standard observer with an aperture angle of 2 degrees. The CIE-XYZ-values are converted into CIE-Lab-values with the use of standard formulas.

A series of spectra are required for the calculation of the model spectrum which can be determined, for example, by spectral measurement of test printouts. A measured (or determined by calculation) reflection spectrum is thereby required for each pigment in the color set. In the case of a three color system, the reflection spectrum of cyan, magenta, yellow, as well as the spectrum of the white paper is required. With the generation of corresponding test printouts, maximum printer-RGB-data are preferably used for the control of the printer in order to achieve the highest possible saturation of the colors. The model could also function with unsaturated colors, if one would allow pigment concentrations higher than 1. Reflection spectra can also be determined depending on the color saturation.

If the reflection spectrum of an image produced by the medium results in cooperation with the reflection spectrum of the medium not provided with pigment, the reflection spectrum of the medium is preferably measured. For paper, this corresponds, for example, to the measurement of a white field.

For the calculation of the reflection spectra R the known CIE-XYZ-color adaptation functions and the relative spectrum of a standard light source, for example, D₆₅, are required.

The determination of the reflection spectra described in the following refers to a light sensitive paper (silver halogenide paper). A similar observation can be carried out, for example, for a system of inkjet printer and normal paper, as described, for example, the printed reference Kang, H. R. (1997), 13.2 Dye Diffusion Thermal Transfer, in: Color Technology for Electronic Imaging Devices, SPIE Optical Engineering Press (Washington, USA), pages 333-341.

Kubelka and Munk formulate a theory for a color mixing with continuous color tones. Their theory is based on two light channels which extend in opposite directions (see FIG. 4). The light is absorbed and scattered in only two directions, namely upward and downward. One assumes that the colored layer is homogeneous and adheres to a background medium or is positioned above the background medium. The background medium has a spectral reflection of P_{g} (8). The colored layer itself has a density of w which extends from w=0 to w=W. For an infinitessimally thin colored layer dw, the absorption rate and scattering rate for upwardly and downwardly directed light can be determined based on the spectral absorption coefficient K(8) and scattering coefficient S(8). Each of the two light channels loses light on the basis of scattering and absorption which are respectively described by the two coefficients K and S. However, the two channels gain respectively from the other channel light and scattering (coefficient S). The light which flows in direction of the reflected light (which means in positive direction dw), is considered positive. This results in a negative sign for the di/dw expression;

−di/dw=−(K+S)i+Sj

dj/dw=−(K+S)j+Si

By substitution of Ψ=j/c one obtains dΨ=(idjjdi)/i²

The above system of the two differential equations can be combined to the equation:

dΨ/dw=S−2(K+S)Ψ+SΨ²

This can also be expressed as follows:

∫dw=∫dΨ/[S−2(K+S)Ψ+SΨ^{2]}

Kang in the above mentioned printed reference, which concerns the Kubelka-Munk Theory, provides a solution for the differential equation for a scatter coefficient of S=0 and the following limit conditions:

w=0: Ψ=P_{g}

w=W: Ψ=P [P(λ) is the reflection of the color film]

The measured reflection spectrum R(λ) is combined with the model reflection spectrum P(λ) by a Saunderson-Correction.

The measured reflection spectrum R is the reflection spectrum measured with the spectrometer, whereby the paper background is measured into it as well. The measured reflection spectra R can be converted to model spectra P and vice versa by the Saunderson-Correction. This is a conversion of measured data to model data, whereby the model spectra P here also incorporate the paper background as far as it was measured into it. The absorption spectra K are without background, since the latter is removed with the help of Pg, whereby Pg is the model spectrum of the background, i.e. the model spectrum of paper white. The absorption spectra K behave linearly in their concentrations and can be mixed.

The Saunderson-Correction applies for the relationship between P and R so that:

P(λ)=R(λ)/[(1−f_{g})(1−fᵢ)+fᵢR(λ)],

whereby fₛ is a constant which describes the surface reflectivity and fᵢ carries out a correction regarding the medium internal scattering. According to the reference F. C. Williams and F. R. Claper (1953), Multiple Internal Reflections in Photographic Color Prints, J. Opt. Soc., 43, 595-599 it is fᵢ=0.615 and fₛ=0 or

P(λ)=R(λ)/[(1−fᵢ)+fᵢR(λ)].

Subsequently, P(λ) is converted into spectral absorptions K(λ), whereby

Kᵢ(λ)=−0.5ln(P(λ)/P_{g}(λ))

whereby P_{g}(λ) is the value of P(λ) of the paper. In this respect, reference is made again to the above mentioned reference of Kang, H. R.

For the total absorption of the pigments it is:

K(λ)=ΣᵢCᵢKᵢ(λ)

whereby Kᵢ(λ) is the spectral absorption of the pigment i and Cᵢ represents the corresponding pigment concentration and the above mentioned second type of over expression is taken into consideration by this summation.

The measured reflection spectra are thus converted into model spectra P and those again into absorption spectra K. Pg is needed for the latter conversion, which is the model spectrum P of the background (paper white), which can be derived from the reflection spectrum of the background (paper). The absorption spectra K are mixed according to the concentrations which, as was mentioned above, behave linearly and, thus, can be mixed without problems. If the mixing process is now completed, the above steps can again be carried out in reverse in order to obtain the reflection spectrum R. Starting from the absorption spectrum K obtained after the mixing, the reflection spectrum of the background is taken into consideration in order to obtain the (mixed) model spectrum P from which is then obtained the mixed and modeled reflection spectrum R. The absorption spectra K thus serve to enable a model conforming mixing of the pigments according to the pigment concentrations determined by the model.

Once the reflection spectrum R is determined, it is folded with the three CIE color sensitivity curves for red, green and blue, whereby a CIE-XYZ-vector results. The Lab values are then calculated therefrom in the known manner.

The absorption spectra K for a specific color can thereby be determined from measurements of reflection spectra on test fields of a specific color, which absorption spectra are then used in a real model essentially unchanged for the above described mixing procedure and can still be idealized in an ideal model before their use. Theoretical absorption spectra K can also be used in an ideal model.

Step 1 of the process shown in FIG. 2 can also be described, for example, with a one-dimensional function respectively for each color (for example three colors) whereby the functions describe especially the S curve for each color. Step 2 of the process shown in FIG. 2 is preferably carried out by multidimensional, especially three-dimensional reference tables, which convert the inflowing densities into the Lab space. The table values are based on the model described herein.

The above described model of a system of image reproduction device and medium was used to recalculate image data entering a system which originate, for example, from a film or a digital camera, so that the appearance of an image produced by the system is output by the model (for example in a standard CIE-Lab color space). The model can also be used for a data flow-through in the opposite direction. In this inverted case, the image data are calculated which are to be entered into a system in order to achieve an image, the appearance of which is described in a given color space (for example CIE-Lab color space).

A model with data flow-through in one direction and a model with data flow-through in reverse direction can be advantageously combined. If the first model (process) describes an ideal system with ideal properties, one can calculate with the first model (process) the ideal appearance of the image data produced with the ideal system. The second model (process), which is used for a reverse data flow-through, describes preferably a real system which is to be used for the image reproduction. This second model then converts the ideal image into image data which are suited for the reproduction with a real system of the ideal image or an image as close as possible thereto.

It is a significant advantage of the model in accordance with the invention compared to a black box model that the number of color tone values which are needed for the adjustment of the model (test printouts or test color fields) can be significantly reduced compared to a black box model. For example, good results are already achieved with test images which represent only three colors and a number of color fields which describe grey tones. Furthermore, stable data result from the model and the gamut limits can easily be calculated. Principally, a small set of color fields of 4 to 28 fields is sufficient, which are measured with a spectrometer. A typical or ideal spectral response of a medium (photographic paper) or of pigments can be sufficient in some cases for the calculation of the Lab values and paper densities. This is true especially when the exposure of an average film onto an average paper is to be described. Parameters are then preferably changed or determined on the basis of the measured values, which parameters set the functions or corresponding table values, for example, in S207, S210, S302, S308, S304 and/or S305. ICC profiles can also be produced from the model which can then be used together with other components (for example input devices) which deliver ICC profile data.

In the data flow-through described above in connection with FIG. 2, the fold of reflection spectra of a number of pigments (and of the background) with especially three spectral sensitivity functions is carried out in step 2 which functions describe, for example, the spectral perception of the human eye, so that three scalars (for example, X, Y, Z of the CIE-XYZ space) are generated. If the data flow-through the model in accordance with the invention is in the opposite direction, an unfolding is required in order to achieve the corresponding printer-RGB-input data (pigment control values). The unfolding can be carried out, for example, in that a multitude of possible reflection spectra are calculated for a given set of primary spectra which were respectively assigned to a pigment and compared with a measured spectrum in order to determine the primary spectra which in combination yield the measured spectrum. Alternatively, polynomial regression processes can also be used. The results achieved thereby are corrected with a reference table of delta values.

The gamut limits are determined by imaging of the edge surfaces of the printer-RGB-cube. The Lab values are determined with a prediction correction process under consideration of the gamut limits. It is thereby first determined whether a given Lab point 7 is within or outside the gamut. Thereafter one determines the point of interception A of the gamut limit with a given curve ( through the Lab point 7 by use of a prediction correction process. Based on the distance |7 A| along the curve (, the origin Lab point 7 is imaged onto a point 7′. The inverse model produces the pigment control values or printer-RGB-values upon input of the Lab point 7′. A set of (curves is formed in the simplest case by straight lines which are parallel to the (A, B) plane and intercept the L-axis.

The second process or the inverted paper model is described in more detail in FIG. 3. The starting point are modulation color values which are represented in the color space platform (LAB) (S301) or modulation color values which are described as paper densities (S307).

The modulation color values are subjected to a reverse function (S302 or S308). The reverse function reverses the function which relates the pigment concentration Cᵢ with the color space platform values or paper densities through the spectra Rₖ. By reversal of this function, the pigment concentrations Cᵢ are obtained in step S303. The illumination densities of the light which correspond to these pigment concentrations, which light produces the pigment concentrations upon incidence onto a photographic paper, are again obtained by reversal of a function. That function is the function shown in FIG. 2 in step S207 which relates the illumination densities to the pigment concentrations. The illumination densities are referred to in FIG. 3 as E* in step S304. Once the illumination densities E* are obtained, a new reverse function is applied which takes into consideration the medium over expression in reverse to the step S206. This reverse function is applied in step S305 and leads to illumination densities Eᵢ from which control values for the control of a printer which exposes photographic paper can be obtained. For the derivation of the reverse functions, reference is again made to the above mentioned reference of Kang, H. R., chapter 3, page 55-63.

1. Process for the modeling of photographic images which are produced by light modulators that modulate an intensity of incident light with respect to the spectrum according to light modulation data, wherein an image reproduction system model determines the light modulation data of the light modulators in response to image control data, the process comprising the steps of:
a) calculating light modulation values (Cᵢ) of the light modulators used for the image reproduction based on the input image control data by modeling the response of the image reproducing system model to the input image control data;
b) calculating, on the basis of the calculated light modulation values, modulation color values which describe the color values of the image which is represented by the light modulators and is generated upon light falling onto the light modulators.

2. Process for the modelling of photographic image data which control the production of a given image by way of an image reproduction system model, wherein the image reproduction system model reproduces the image by way of light modulators which modulate the intensity and/or spectrum of the incident light according to light modulation values, wherein the image reproduction system model determines the light modulation values of the light modulators in response to image control data, the process comprising the steps of:
a) calculating light modulation values (Cᵢ) based on modulation color values which describe the color values of the image reproduced by the light modulators upon light falling onto the image;
b) based on the calculated light modulation values, calculating image control data corresponding to the image which lead to the production of the image by way of light modulators when they are input into the image reproducing system model, in that the modeled answer of the image reproducing system model to incoming image data is inverted.

3. Process according to claim 1 or 2, wherein multiple types of light modulators are present, with each type of light modulator having given spectral modulation properties, and the process comprises the further step of determining the modulation strength, which is achieved in image portions by light modulators of one specific type, by way of the image reproducing system model, whereby the modulation strength depends on the image control data, which dependency is taken into consideration for the modeling of the answer of the image reproducing system model to the input image data.

4. Process according to claim 3, wherein the light modulation values describe the modulation strength of the light modulators in the image regions and the process comprises the further step of relating the light modulation values (Cᵢ) to the modulation color values (Lab) by way of the spectral modulation properties.

5. Process according to claim 1 or 2, wherein the step of modeling the answer of the image reproduction system model includes the step of describing the adaptation of the dynamic range of the color densities reproducible in the image control data color space to the dynamic range of the color densities reproducible by the light modulators.

6. Process according to claim 1 or 2, wherein the step of modeling the answer of the image reproduction system model includes the step of describing an over expression at the light modulators, wherein the over expression causes an overlapping of the spectral properties of the light modulators.

7. Process according to claim 1 or 2, wherein the step of modeling the answer of the image reproduction system model includes the step of describing an adaptation of the color tone range reproducible in the color space of the image control data to the color tone range reproducible by the light modulators.

8. Process according to claim 1 or 2, wherein the light modulators are pigments and the light modulation values determine at least one factor selected from the group of the concentration, the amount and the spacial distribution of pigments for a given set of pigments used for the image reproduction.

9. Process according to claim 1 or 2, comprising the step of relating the light modulation values with the modulation color values by considering the light incidence, based on at least one factor selected from the group of the absorption, transmission and reflection spectra of the light modulators, the emission properties of the illumination light source, and the modeled light modulation properties of a medium, which is part of the image reproduction system model and on or in which the light modulators are positioned.

10. Process for the modeling of photographic images comprising the steps of first carrying out the process according to claim 1 and then, based on the modulation color values obtained, carrying out the process according to claim 2.

11. Process according to claim 10, whereby an ideal image reproducing system model is used as the basis for the determination of the modulation color values with the process of claim 1, and another, real image reproducing system model is used as the basis for the calculation of the image data with the process of claim 2, wherein in an ideal image reproducing system model the difference between the color values produced by the image control data of claim 1, and the modulation color values is smaller than in a real image reproducing system model, and the image control data of claim 2, are input into a real image reproducing system corresponding to the real image reproducing system model.

12. Software which, when running on a computer or loaded in a computer, initiates the computer to carry out the process according to claim 1 or 2.

13. Storage medium for a computer program comprising the software according to claim 12.

14. Printer or scanner, comprising a control device for carrying out the process according to claim 1 or 2.

15. Printer according to claim 14, whereby image control data calculated by use of the process according to claim 2, are input into the control device of the printer and the image reproducing system model mirrors the properties of the printer and the medium used by the printer.

16. Photolab, comprising a control device for carrying out the process according to claim 1 or 2.

17. Photolab, comprising a printer or scanner according to claim 14.

18. Photolab according to claim 16 or 17, wherein the photolab is minilab or a large scale lab.

19. Photolab according to claim 18, wherein the control device is a computer.

20. Use of a model for an image reproducing system for the generation of photographic images in a process, an apparatus, a program or a business model, wherein the photographic images are reproduced by light modulators which modulate the intensity and/or spectrum of the incident light and the light modulation values of which describe the light modulation by the light modulators and whereby the image reproducing system model determines the light modulation values of the light modulators in response to image control data, the model comprising the steps of:
generating a relationship between light modulation values (Cᵢ) and the input image control data by modeling of the answer of the image reproducing system model to the input image control data; and
generating a relationship between the modulation color values of an image and the light modulation values (Cᵢ) based on a modeled light incidence onto the light modulators.

21. Use according to claim 20, wherein the model uses process steps according to claim 1 or 2.
